(19) United States
(12) Patent Application Publication
(10) Pub. No.: US 2011/0302847 A1
(43) Pub. Date: Dec. 15, 2011

(54) ADJUSTABLE LOCK BODY ASSEMBLY

(75) Inventor: Wesley Byron JOHNSON, Fletcher, NC (US)

(73) Assignee: EATON CORPORATION, Cleveland, OH (US)

(21) Appl. No.: 12/815,686

(22) Filed: Jun. 15, 2010

(51) Int. Cl. E06B 7/00; F16M 13/00; B23P 11/00; E05B 17/00

(52) U.S. Cl. 49/503; 70/466; 248/274.1; 29/525.11

(57) ABSTRACT

An adjustable lock body assembly is provided that selectively secures an enclosure door in the closed position. The adjustable lock body assembly is affixed to the enclosure and is configured to be, at the same time, moveable with respect to the enclosure while the door is in the closed position and operable to selectively secure the enclosure door.

### BACKGROUND

Many enclosures are provided with lock body assemblies that engage a latch block to lock an enclosure door to the enclosure, thereby impeding access to the contents of the enclosure. One specific type of lock body assembly is a keyed interlock assembly, sometimes called a “Kirk key”. In a keyed interlock, the key may only be removed from the lock when the lock bolt is in a particular position. This means that use of the key to operate other interlocks is only possible when a device secured with the keyed interlock is in a predetermined condition. For example, a keyed interlock is often provided on enclosures that house circuit breakers. The same key is used to lock a circuit breaker in an open position and to open an access door to the enclosure that provides access to a circuit protected by the circuit breaker. The key is held by the circuit breaker keyed interlock until the breaker is locked open so that key may not be used to open the access door when the circuit breaker has not been locked open.

Enclosures that include lock body assemblies are subject to misalignment between the lock bolt and the latch block which prevents proper operation of the lock. A lock body assembly is realigned with the latch block by loosening fasteners that mount the lock body assembly to the enclosure, moving the lock body assembly to a position in which it is aligned with the latch block, and tightening the fasteners to fix the lock body into position. In some enclosures, it is necessary to pry the lock body assembly into position. In general, it is necessary to access the interior of the enclosure to make adjustments, which is time consuming.

### SUMMARY

An adjustable lock body assembly is provided that enables position adjustments of a lock body on an enclosure to be made without requiring access to an interior of the enclosure. In one example embodiment, the adjustable lock body assembly includes a mounting plate retaining assembly and a lock body mounting plate configured to be connected to a lock body that controls an extendable bolt. The mounting plate retaining assembly captures the lock body mounting plate in a manner that allows movement of the lock body mounting plate relative to the mounting plate retaining assembly while preventing the lock body mounting plate from coming out of engagement with the mounting plate retaining assembly. When the lock body is installed on the lock body mounting plate, a position of the lock body mounting plate within the mounting plate retaining assembly is capable of being adjusted by movement of the lock body. The mounting plate retaining assembly is also configured to capture the lock body mounting plate such that the lock body mounting plate remains moveable relative to the mounting plate retaining assembly during normal operation of the lock body.

In some example embodiments, the lock body mounting plate includes at least two flange portions configured to extend beyond at least two opposing edges of the lock body that are captured by the mounting plate retaining assembly.

In some example embodiments, the mounting plate retaining assembly defines an interior cavity that envelops the lock body mounting plate while providing a predetermined amount of clearance with respect to the lock body mounting plate in at least one direction. In these embodiments, the mounting plate retaining assembly defines a front cavity opening sized to permit access to at least a portion of the lock body while not allowing passage of the lock body mounting plate. The mounting plate retaining assembly also defines a rear cavity opening sized to permit passage of the lock body while not allowing passage of the lock body mounting plate.

In some embodiments, the mounting plate retaining assembly includes a front frame affixed to a rear frame. The front frame defines the front cavity opening and the rear frame defines the rear cavity opening. The mounting plate retaining assembly also includes an offset feature that creates clearance between portions of the front and rear plates. The clearance defines the cavity when the front and rear plates are positioned adjacent to one another. The offset feature may include a raised peripheral lip that protrudes from one or both of the front or rear plates.

In some embodiments, the adjustable lock body assembly includes a trim piece that is configured to rest against an exterior surface of the enclosure and to be affixed to the front frame with a fastener that protrudes through the enclosure member to fix the adjustable lock body assembly to the enclosure member.

In some embodiments, the adjustable lock body assembly includes one or more mounting plate retaining studs that protrude into the cavity from one or both of the front and rear frames. The studs apply a biasing force perpendicular to a surface of the lock body mounting plate to provide frictional resistance to movement of the lock body mounting plate within the cavity.

In some embodiments, the mounting plate retaining assembly includes a pair of spaced fixed rails connected to an enclosure member on which the apparatus is affixed. The fixed rails include one or more fixed rail slots. The mounting plate retaining assembly also includes a pair of spaced floating rails arranged substantially perpendicular to the pair of fixed rails to define an opening through which at least a portion of the lock body may pass. The floating rails include one or more floating rail slots and are connected to the fixed rails at distal ends with at least one first type of fastener inserted through a respective one of the at least one fixed rail slot such that the floating rail is moveable with respect to the fixed rail along an excursion defined by the fixed rail slot.

The mounting plate is connected to the floating rail with at least one second type of fastener inserted through a respective one of the at least one floating rail slots such that the mounting plate is moveable with respect to the floating rail along an excursion defined by the floating rail slot. Either the first type of fastener, the second type of fastener, or both types of fasteners include a fastener head and a fastener end on opposing distal ends of a fastener stem to provide for relative movement along the stem between the fixed and floating rail or the rail and plate connected by the fastener.

A method for adjusting a position of a lock body includes engaging an adjustable lock body assembly on a closed enclosure. The method also includes, while the enclosure is closed, moving the adjustable lock body assembly into a position in which a lock bolt is aligned with a latch block inside the closed enclosure. The alignment may be performed by moving the adjustable lock body assembly into a position in which alignment pins on the latch block are inserted into receiving holes in the adjustable lock body assembly. The bolt is extended to engage the latch block; and installation of the closed enclosure is completed without re-entering the enclosure to fix the adjustable lock body assembly in position.

In some embodiments, an enclosure is provided that includes an enclosure door that is configured to be moveable between a closed position with respect the enclosure to impede access to an interior of the enclosure and an open position in which the interior of the enclosure is made accessible. The enclosure also includes an adjustable lock body assembly that selectively secures the enclosure door in the closed position. The adjustable lock body assembly is affixed to the enclosure and is configured to be, at the same time, moveable with respect to the enclosure while the door is in the closed position and operable to selectively secure the enclosure door.

### BRIEF DESCRIPTION OF THE DRAWINGS

The accompanying drawings, which are incorporated in and constitute a part of the specification, illustrate various example systems, methods, and other embodiments of various aspects of the invention. One of ordinary skill in the art will appreciate that in some embodiments one element may be designed as multiple elements, multiple elements may be designed as one element, an element shown as an internal component of another element may be implemented as an external component and vice versa, and so on. Furthermore, elements may not be drawn to scale.

FIG. 1 illustrates an enclosure that includes an example embodiment of an adjustable lock body assembly.

FIG. 2 illustrates the enclosure of FIG. 1 with an enclosure door open to show an example embodiment of an adjustable lock body assembly.

FIG. 3 is a perspective view of an example embodiment of an adjustable lock body assembly.

FIG. 4 is a front view of the adjustable lock body assembly of FIG. 3.

FIG. 4a is a cross section view of the adjustable lock body assembly as shown in FIG. 4.

FIG. 5 is a rear view of the adjustable lock body assembly of FIG. 3.

FIG. 5a is a cross section view of the adjustable lock body assembly as shown in FIG. 5.

FIG. 6 is a cross section view of another an example embodiment of an adjustable lock body assembly.

FIG. 7 is a perspective view of an example embodiment of an adjustable lock body assembly.

FIG. 8 is a perspective view of the adjustable lock body assembly of FIG. 7 with a key body mounting plate removed to reveal details hidden by the plate.

FIG. 9 is a front view of the example embodiment of an adjustable lock body assembly shown in FIG. 7.

FIG. 9a is a cross section view of the adjustable lock body assembly as shown in FIG. 9.

FIG. 9b is a cross section view of the adjustable lock body assembly as shown in FIG. 9.

### DETAILED DESCRIPTION

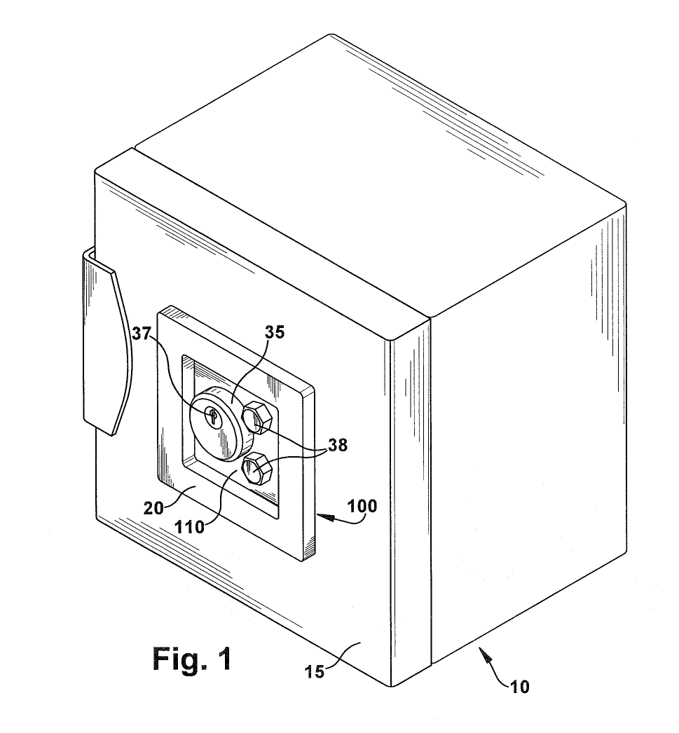

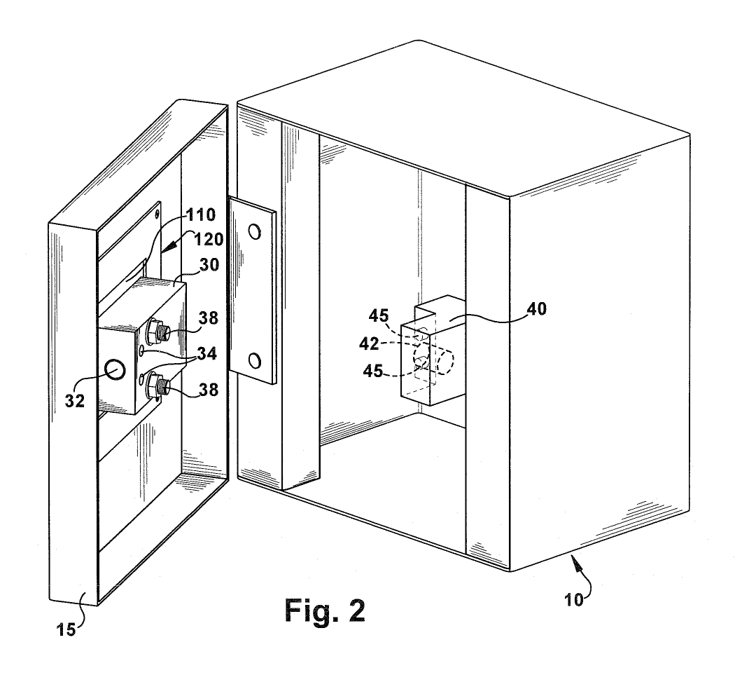

FIG. 1 illustrates an enclosure 10 that includes a door 15 on which an adjustable lock body assembly 100 is affixed. The enclosure may be, for example, an electrical cabinet that is secured with a keyed interlock. Of course, the enclosure may also be any type of enclosure that has a door that is secured with a lock body. The adjustable lock body assembly includes a lock body mounting plate 110 through which a lock cylinder 35 protrudes to be accessed by users of the enclosure. A trim piece 20 is installed in front of the lock body mounting plate 110 to provide a finished appearance. Mounting bolts 38 can be seen, which are used to mount a lock body 30 (see FIG. 2) to the lock body mounting plate 110.

FIG. 2 illustrates the enclosure 10 with the door 15 open. The lock body 30, which includes an extendable bolt 32, is connected to the lock body mounting plate 110. The lock body mounting plate 110 is moveably captured within a mounting plate retaining assembly 120 as will be described in greater detail below. The lock body mounting plate 110 may thus be moved within a limited envelope defined by the mounting plate retaining assembly 120 by moving the lock cylinder 35 (see FIG. 1), which can be accessed from outside the enclosure. A latch block 40 is fixed inside the enclosure. The latch block 40 includes a bolt keeper opening 42 configured to receive and retain the bolt 32 to secure the door 15 to the enclosure 10. The latch block 40 may include alignment pins 45 that align with alignment holes 34 in the lock body 30 when the bolt 32 is properly aligned with the keeper opening 42.

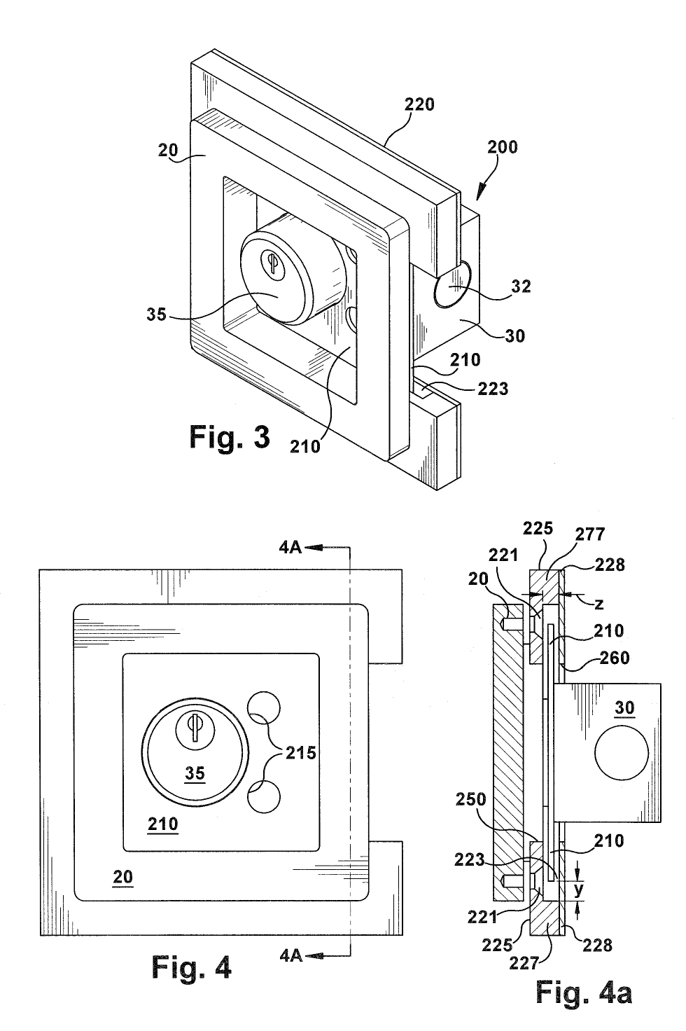

FIGS. 3-5a illustrate one example embodiment of an adjustable lock body assembly 200. The adjustable lock body assembly 200 is configured to mount the lock body 30 to an enclosure (not shown) in a manner that allows the position of the lock body to be adjusted without having to access an interior of the enclosure. The adjustable lock body assembly 200 includes a lock body mounting plate 210 and a mounting plate retaining assembly 220. The mounting plate retaining assembly 220 defines a cavity 223 in which the mounting plate 210 is moveably retained.

FIG. 4 is a front view of the adjustable lock body assembly 200 in which mounting bolt holes 215 can be seen in the lock body mounting plate 210 to provide passage for the mounting bolts 38 (FIG. 1). The key cylinder 35 protrudes through the lock body mounting plate 210 so that it can be accessed from outside the enclosure. FIG. 4a is a cross section view of the adjustable lock body assembly 200 taken as indicated in FIG. 4. In the example embodiment shown in FIGS. 3-5a, the mounting plate retaining assembly 220 includes a front frame 225 that defines a front opening 250 to the cavity 223 that houses the lock body mounting plate 210. The front frame 225 is connected to a rear frame 228 that defines a rear opening 260 to the cavity 223. An offset feature 227 creates the cavity 223 when the front and rear frames 225, 228 are connected to one another. In the illustrated example, the offset feature 227 is embodied as a raised lip on a periphery of the front frame 225. During use of the enclosure, movement of the lock body mounting plate 210 within the mounting plate retaining assembly 220 in the “y” and “z” axes is permitted as indicated. The optional trim piece 20 may be connected to the front frame 225, through the enclosure door (not shown) with fasteners installed in counterbores 221.

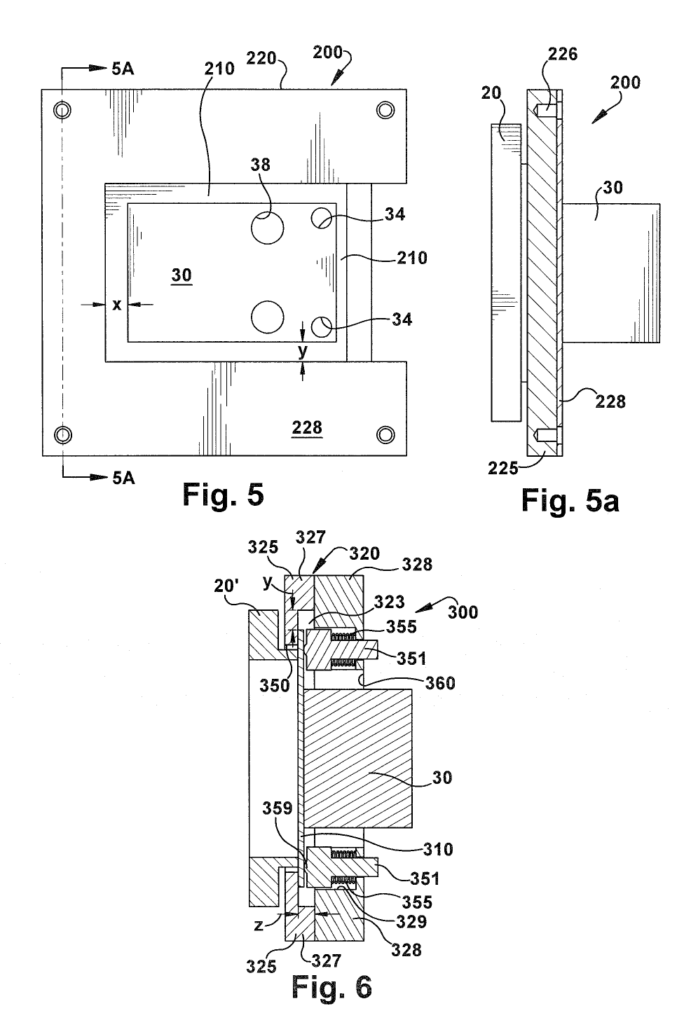

FIG. 5 is a rear view of the adjustable lock body assembly 200. Optional alignment holes 34 are shown in the lock body 30 that may be used to align the lock body in with the latch block 40 (FIG. 2) as already described above. Movement by the lock body mounting plate 210 within the mounting plate retaining assembly 220 in the “x” and “y” axes is permitted as indicated. FIG. 5a is a cross section view of the adjustable lock body assembly 200 taken as indicated in FIG. 5. Tapered holes 226 in the front frame 225 are configured to accept threaded fasteners to connect the front frame 225 to the rear frame 228.

FIG. 6 is a cross section view of another example embodiment of an adjustable lock body assembly 300 that is similar to the embodiment of FIGS. 3-5a. In the example embodiment shown in FIG. 6, a mounting plate retaining assembly 320 includes a front frame 325 that defines a front opening 350 to a cavity 323 that houses a lock body mounting plate 310. The front frame 325 is connected to a rear frame 328 that defines a rear opening 360 to the cavity 323. An raised lip 327 on a periphery of the front frame creates the cavity 323 when the front and rear frames 325, 328 are connected to one another. Movement by the lock body mounting plate 310 within the mounting plate retaining assembly 320 in the “y” and “z” axes is permitted as indicated. An optional trim piece 20′may be connected to the front frame 325, through the enclosure door (not shown).

The adjustable lock body assembly 300 includes features that provide a preload force on the lock body mounting plate 310 to provide frictional resistance to motion of the lock body mounting plate. The rear frame 328 includes stud receiving bores 329 that are configured to house a stud 351. The stud 351 includes a blunt point 359 that rides on the surface of the lock body mounting plate 310. A biasing spring 355 is disposed around a stem of the stud and co-acts with the stud receiving bore 329 to urge the blunt point 359 against the lock body mounting plate.

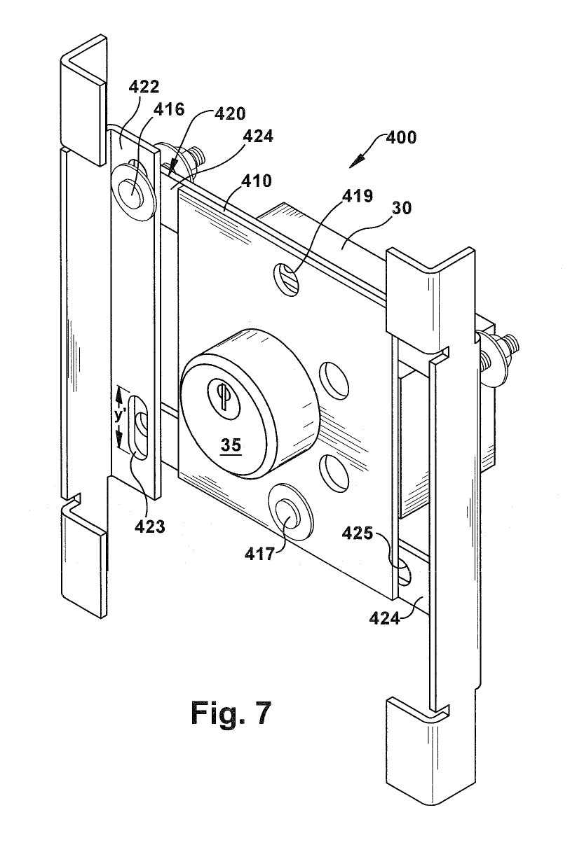

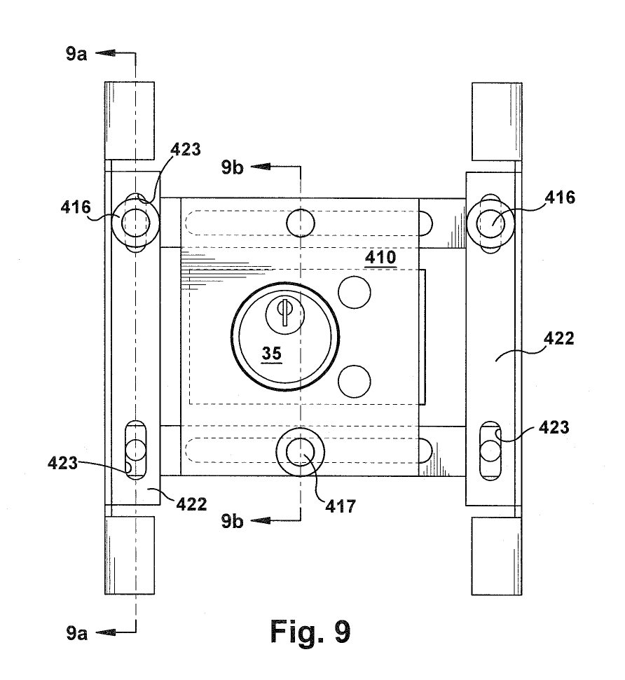

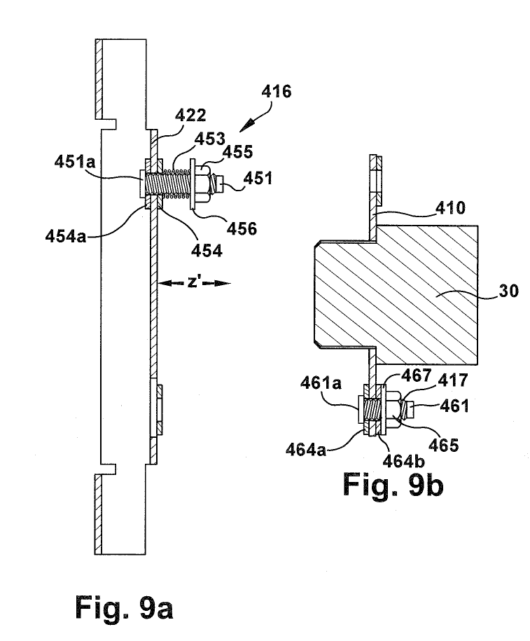

FIGS. 7-9b illustrate another embodiment of an adjustable lock body assembly 400 that includes a mounting plate retaining assembly 420 that uses co-acting slotted rails to moveably retain a lock body mounting plate 410. The mounting plate retaining assembly 420 includes a pair of fixed rails 422 (both fixed rails 422 are visible in FIG. 9) and a pair of floating rails 424. The fixed rails 422 are fixed with respect to the enclosure and include fixed rail slots 423. The pair of floating rails 424 is connected to the fixed rails 422 by way of a first type of fastener 416 inserted through the fixed rails slots 423. Thus, the floating rails 424 may move relative to the fixed rails 422 along a y axis in an excursion defined by the fixed rail slots 423.

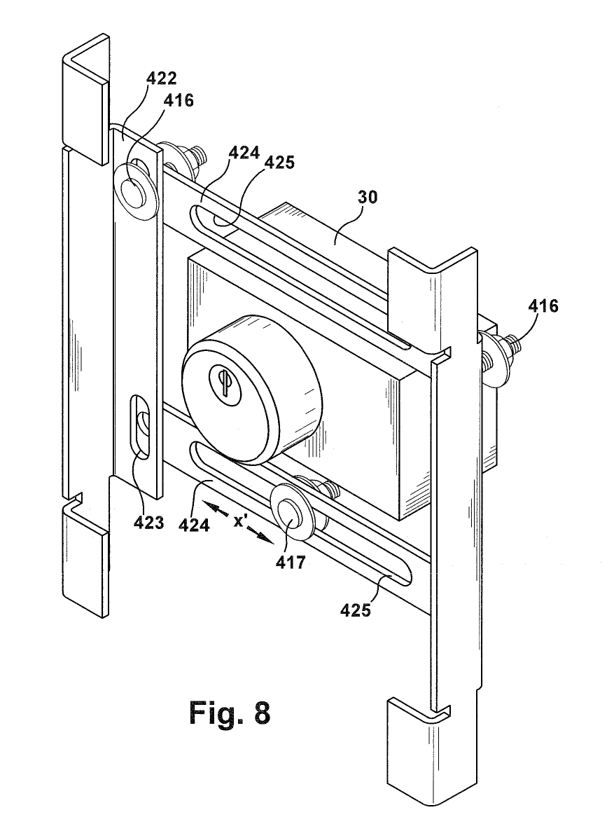

FIG. 8 illustrates the adjustable lock body assembly 400 without the lock body mounting plate 410 to better show the floating rails 424. The floating rails 424 include a floating rail slot 425. The lock body mounting plate 410 (not shown) is mounted to the floating rails 424 by way of a second type of fastener 417 inserted through the floating rail slots 425. Thus, the key body mounting plate 410 may move relative to the floating rails 424 along an x axis in an excursion defined by the fixed rail slots 425.

FIG. 9 is a rear view of the lock body assembly 400 shown in FIG. 8. FIG. 9a is a cross section view of the adjustable lock body assembly 400 taken as shown in FIG. 9. FIG. 9a illustrates an example embodiment of the first type of fastener 416 in more detail The first type of fastener 416 includes a threaded stud 451, a nut 455, a bushing 456, and a washer 454a that is disposed between a stud head 451a and the fixed rail 422. The first type of fastener also includes another washer 454b that is disposed between the fixed rail 422 and a biasing spring 453. The biasing spring 453 co-acts with the bushing 456 and the washer 454b to apply a biasing force that urges the head 451a toward the fixed rail 422. When the head 451a is thus arranged, clearance is created along a stem of the stud 451 for the floating rail to be moved along a z axis as indicated for adjustment purposes.

FIG. 9b is a cross section view of the adjustable lock body assembly 400 taken as shown in FIG. 9. FIG. 9b illustrates an example embodiment of the second type of fastener 417 in more detail The second type of fastener 417 includes a threaded stud 461, a nut 465, a bushing 467, and a washer 464a that is disposed between a stud head 461a and the lock body mounting plate 410. The second type of fastener 417 also includes another washer 464b that is disposed between the lock body mounting plate 410 and the bushing 467. While no clearance is created along the threaded stud 461 for movement of the lock body mounting plate 410 along the z axis, the second type of fastener could be adapted to provide this clearance if desired.

The apparatus described above are advantageous for employing a method for adjusting a position of a lock body without accessing an interior of the enclosure that is secured by the lock body. The method includes engaging an adjustable lock body assembly on a closed enclosure. The method also includes, while the enclosure is closed, moving the adjustable lock body assembly into a position in which a lock bolt is aligned with a latch block inside the closed enclosure, the latch block being configured to retain the lock bolt to fix the door to the enclosure. The alignment may be performed by moving the adjustable lock body assembly into a position in which alignment pins on the latch block are inserted into receiving holes in the adjustable lock body assembly. The bolt is extended to engage the latch block; and installation of the closed enclosure is completed without re-entering the enclosure to fix the adjustable lock body assembly in position.

The apparatus described above may be employed as part of an enclosure that includes an enclosure door that is configured to be moveable between a closed position with respect the enclosure to impede access to an interior of the enclosure and an open position in which the interior of the enclosure is made accessible. The enclosure also includes an adjustable lock body assembly that selectively secures the enclosure door in the closed position. The adjustable lock body assembly is affixed to the enclosure and is configured to be, at the same time, moveable with respect to the enclosure while the door is in the closed position and operable to selectively secure the enclosure door.

To the extent that the term “or” is employed in the detailed description or claims (e.g., A or B) it is intended to mean “A or B or both”. The term “and/or” is used in the same manner, meaning “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C.

When the applicants intend to indicate “at least one of A, at least one of B, and at least, one of C”, then the phrasing “at least one of A, at least one of B, and at least one of C” will be employed.

What is claimed is:

1. An apparatus, comprising:
a lock body mounting plate configured to be connected to a lock body;
a mounting plate retaining assembly that captures the lock body mounting plate in a manner that allows movement of the lock body mounting plate relative to the mounting plate retaining assembly while preventing the lock body mounting plate from coming out of engagement with the mounting plate retaining assembly; and
where, when the lock body is installed on the lock body mounting plate, a position of the lock body mounting plate within the mounting plate retaining assembly is capable of being adjusted by movement of the lock body and further where the mounting plate retaining assembly is configured to capture the lock body mounting plate such that the lock body mounting plate remains moveable relative to the mounting plate retaining assembly during normal operation of the lock body.

2. The apparatus of claim 1 where the lock body mounting plate comprises at least two flange portions configured to extend beyond at least two opposing edges of the lock body, the at least two flange portions being captured by the mounting plate retaining assembly.

3. The apparatus of claim 1 where the mounting plate retaining assembly defines an interior cavity that envelops the lock body mounting plate while providing a predetermined amount of clearance with respect to the lock body mounting plate in at least one direction, the mounting plate retaining assembly defining a front cavity opening sized to permit access to at least a portion of the lock body while not allowing passage of the lock body mounting plate, the mounting plate retaining assembly also defining a rear cavity opening sized to permit passage of the lock body while not allowing passage of the lock body mounting plate.

4. The apparatus of claim 3 where the mounting plate retaining assembly comprises:
a front frame that defines the front cavity opening;
a rear frame affixed to the front frame, the rear frame defining the rear cavity opening; and
an offset feature that creates clearance between portions of the front and rear plates, the clearance defining the cavity when the front and rear plates are positioned adjacent to one another.

5. The apparatus of claim 4 where the offset feature comprises a raised peripheral lip that protrudes from one or both of the front and rear plates.

6. The apparatus of claim 4 including a trim piece that is configured to rest against an exterior surface of an enclosure and to be affixed to the front frame with a fastener that protrudes through the enclosure to fix the apparatus to the enclosure.

7. The apparatus of claim 4 further including one or more mounting plate retaining studs that protrude into the cavity from one or both of the front and rear frames, the retaining studs applying a biasing force perpendicular to a surface of the lock body mounting plate to provide frictional resistance to movement of the lock body mounting plate within the cavity.

8. The apparatus of claim 1 where the mounting plate retaining assembly comprises:
a pair of spaced fixed rails connected to an enclosure member on which the apparatus is affixed, the fixed rails including one or more fixed rail slots;
a pair of spaced floating rails arranged substantially perpendicular to the pair of fixed rails to define an opening through which at least a portion of the lock body may pass, the floating rails including one or more floating rail slots and being connected to the fixed rails at distal ends with at least one first type of fastener inserted through a respective one of the at least one fixed rail slot such that the floating rail is moveable with respect to the fixed rail along an excursion defined by the fixed rail slot;
the mounting plate being connected to the floating rail with at least one second type of fastener inserted through a respective one of the at least one floating rail slots such that the mounting plate is moveable with respect to the floating rail along an excursion defined by the floating rail slot.

9. The apparatus of claim 8 where either the first type of fastener, the second type of fastener, or both types of fasteners includes a fastener head and a fastener end on opposing distal ends of a fastener stem to provide for relative movement along the stem between the fixed and floating rail or the rail and plate connected by the fastener.

10. A method comprising:
engaging an adjustable lock body assembly on a closed enclosure, the closed enclosure including an enclosure body and a door that is in a closed position, the adjustable lock body being moveable with respect to the closed enclosure;
while the enclosure is closed, moving the adjustable lock body assembly into a position in which a lock bolt is aligned with a latch block inside the closed enclosure, the latch block being configured to retain the lock bolt to fix the door to the enclosure;
extending the bolt to engage the latch block; and
completing installation of the closed enclosure without re-entering the enclosure to fix the adjustable lock body assembly in position.

11. The method of claim 10 where the step of engaging an adjustable lock body assembly is performed by engaging an adjustable lock body assembly on the door of the cabinet and further where the latch block is installed in the enclosure body.

12. The method of claim 10 where the step of moving the adjustable lock body assembly into a position in which a lock bolt is aligned with a latch block inside the closed enclosure is performed by moving the adjustable lock body assembly into a position in which alignment pins on the latch block are inserted into receiving holes in the adjustable lock body assembly.

13. An apparatus comprising:
means for mounting a lock body;
means for capturing the means for mounting in a manner that allows for limited movement of the means for mounting relative to the means for capturing; and
where, when the lock body is installed on the means for mounting, a position of the means for mounting within the means for capturing is capable of being adjusted by movement of the lock body and further where means for capturing is configured to capture the means for mounting such that the means for mounting remains moveable relative to the means for capturing during normal operation of the lock body.

14. An enclosure comprising:
an enclosure door that is configured to be moveable between a closed position with respect the enclosure to impede access to an interior of the enclosure and an open position in which the interior of the enclosure is made accessible;
an adjustable lock body assembly that selectively secures the enclosure door in the closed position, the adjustable lock body assembly being affixed to the enclosure and being configured to be, at the same time, moveable with respect to the enclosure while the door is in the closed position and operable to selectively secure the enclosure door.
